(19) United States
(12) Patent Application Publication
(10) Pub. No.: US 2025/0330444 A1
(43) Pub. Date: Oct. 23, 2025

(54) Processing DHCP Renewals in an SDA Environment

(71) Applicant: Cisco Technology, Inc., San Jose, CA (US)

(72) Inventors: Sajid Sayedrasul Inamdar, Bengaluru (IN); Roberto M. Kobo, San Jose, CA (US); Raghupathy Sekar, San Jose, CA (US); Oliver W. I'Anson, Berkshire (GB)

(21) Appl. No.: 18/643,112

(22) Filed: Apr. 23, 2024

(51) Int. Cl. H04L 61/5053; H04L 61/5014

(52) U.S. Cl. CPC H04L 61/5053; H04L 61/5014

(57) ABSTRACT

In an embodiment, a method for dynamic host configuration protocol (DHCP) renewal is performed. A first router intercepts a DHCP renewal request sent by a local device to a remote DHCP server. The first router is one of a plurality of routers positioned between the local device and the remote DHCP server, and the plurality of routers form a mesh network. After the DHCP renewal request is intercepted, a determination is made if a gateway address corresponding to the first router and a DHCP option is present in the DHCP renewal request. If they are not, the gateway address and DHCP option are inserted into the DHCP renewal request by the first router. The DHCP renewal request is forwarded from the first router to the remote DHCP server. The first router then receives an acknowledgment sent by the remote DHCP server and forwards it to the local device.

### TECHNICAL FIELD

The present disclosure generally relates to a computer network and, more particularly, to a method and apparatus for processing dynamic host configuration protocol (DHCP) renewals in a software-defined access (SDA) environment.

### BACKGROUND

Organizations have increasingly utilized larger and more complicated networks to provide network services to geographically dispersed devices. These networks may be organized as a mesh and/or a software-defined access network. Because these kinds of networks potentially include many routers and other network devices, messages between a device and a remote server may be treated differently than in traditional networks,

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems and components depicted in the accompanying figures are not to scale, and components within the figures may be depicted not to scale with each other.

FIG. 1 illustrates a system for performing DHCP renewal in accordance with at least one embodiment.

FIG. 2 illustrates a signaling diagram for performing DHCP renewal in accordance with at least one embodiment.

FIG. 3 illustrates a flow diagram of a method for performing DHCP renewal in accordance with at least one embodiment.

FIG. 4 illustrates a computer architecture diagram shown in an illustrative computer hardware architecture in accordance with at least one embodiment.

### DESCRIPTION OF EXAMPLE EMBODIMENTS

### Overview

According to an embodiment, the disclosure describes a method for performing DHCP renewals. The method includes intercepting, by a first router, a DHCP renewal request communicated by a local device to a remote DHCP server. The first router is one of a plurality of routers forming a mesh network positioned between the local device and the remote DHCP server. The method determines if a gateway address, which is the address of the first router, and DHCP options are present in the DHCP renewal request. The gateway address and a DHCP option are then added to the DHCP renewal request when it is determined that the gateway address and DHCP options are not present in the DHCP renewal request. The DHCP renewal request is then forwarded from the first router to the remote DHCP server. The first router receives an acknowledgment communicated by the remote DHCP server, wherein the acknowledgment is communicated to the gateway address. The first router then forwards the acknowledgment to the local device. While described as being performed for DHCP renewal, a similar approach may be performed for other similar DHCP communications, such as a DHCP information request (DHCPINFORM).

According to another embodiment, the disclosure describes a first router. The first router comprises one or more processors and one or more computer-readable non-transitory storage media coupled to the one or more processors that store instructions. The instructions are operable when executed by the one or more processors to cause the first router to perform operations. The operations include intercepting, by a first router, a DHCP renewal request communicated by a local device to a remote DHCP server. Determining if a gateway address, which is the address of the first router, and DHCP options are present in the DHCP renewal request. The gateway address and a DHCP option are then added to the DHCP renewal request when it is determined that the gateway address and DHCP options are not present in the DHCP renewal request. The DHCP renewal request is then forwarded from the first router to the remote DHCP server. The first router receives an acknowledgment communicated by the remote DHCP server, wherein the acknowledgment is communicated to the gateway address. The first router then forwards the acknowledgment to the local device.

According to yet another embodiment, the disclosure describes one or more computer-readable non-transitory storage media embodying instructions that, when executed by a processor, cause the processor to perform operations. The operations comprise intercepting, by a first router, a DHCP renewal request communicated by a local device to a remote DHCP server. The first router is one of a plurality of routers forming a mesh network positioned between the local device and the remote DHCP server. The operations determine if a gateway address, which is the address of the first router, and DHCP options are present in the DHCP renewal request. The gateway address and a DHCP option are then added to the DHCP renewal request when it is determined that the gateway address and DHCP options are not present in the DHCP renewal request. The DHCP renewal request is then forwarded from the first router to the remote DHCP server. The first router receives an acknowledgment communicated by the remote DHCP server, wherein the acknowledgment is communicated to the gateway address. The first router then forwards the acknowledgment to the local device.

According to an embodiment, the mesh network is in an SDA environment, such as an SDA network. The mesh network includes a second router for routing an acknowledgment through the mesh network to the first router. A fusion router may also be provided to forward packets to and from the DHCP server to the second router and onto the mesh network. According to an embodiment, the first router receives the acknowledgment as a unicast message sent to the gateway address and forwards the acknowledgment as a broadcast message to the local device. The DHCP renewal request also has option 82 configured.

Technical advantages of certain embodiments of this disclosure may include one or more of the following. Certain systems and methods described herein may allow for providing DHCP renewal in a mesh network such as an SDA fabric network. By inserting a gateway internet protocol (IP) address (GIADDR) of the edge node into a DHCP renewal, the DHCP renewal and acknowledgment messages may successfully navigate the mesh network, and a local device's DHCP may be successfully renewed without having to make any changes to the DHCP server or local device.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

The present disclosure describes an approach that allows for efficient processing of DHCP renewals in mesh networks such as an SDA network. The DHCP renewal request is intercepted by an edge node of the mesh network, which inserts a gateway IP address in the GIADDR address field of the DHCP renewal packet and adds a DHCP option (e.g., Option-82). This allows the DHCP acknowledgment packet (DHCPACK) to be sent back as a unicast packet instead of a broadcast packet. The unicast packet or message is addressed to the gateway or first router instead of as a broadcast packet. This avoids the problem that often occurs in mesh networks, such as SDA networks, where the broadcast acknowledgment packet sent from the DHCP server is terminated at a fusion router or other router nearest the DHCP server.

While this could potentially be addressed by making changes in the DHCP server, such a change requires advanced technical abilities, as well as access to the DHCP server, which may not be possible. Further, not all DHCP servers are able to implement some of these changes, and/or the DHCP server may belong to a different organization than the mesh network. The present disclosure only requires changes to the networking devices associated with the mesh network 120, such as the edge node or first router. There is no requirement to configure client-subnet routes or reconfigure the DHCP server.

The various aspects may be implemented in many different forms and should not be construed as limited to the implementations set forth herein. The disclosure encompasses variations of the embodiments as described herein. Like numbers refer to like elements throughout.

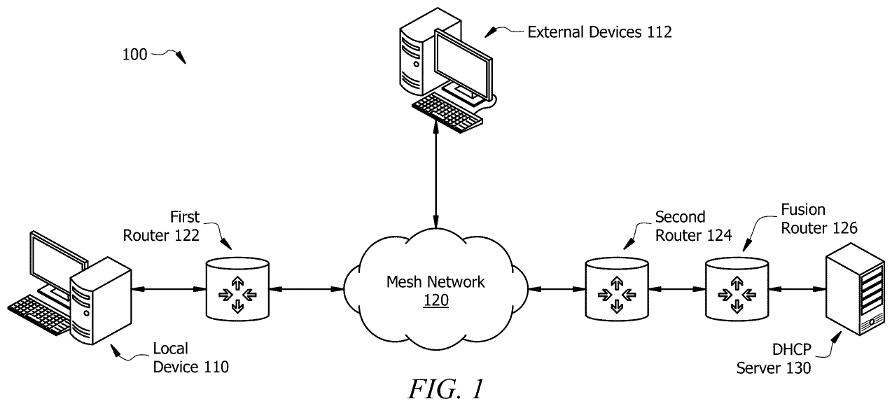

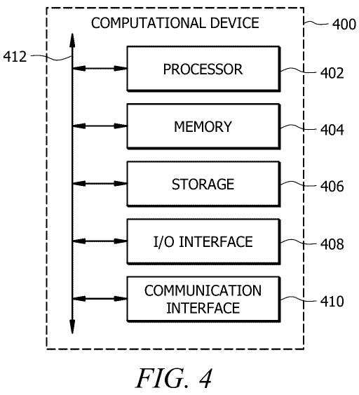

FIG. 1 illustrates a diagram of an example system 100 for providing DHCP services over a mesh network 120, such as an SDA fabric network to a local device 110. In one or more embodiments, the system 100 includes a mesh network 120, a local device 110, other external devices 112, and a DHCP server 130. The mesh network 120 comprises a plurality of routers and other network equipment organized as a fabric or in another organizational scheme. The mesh network 120 includes at least a first router 122 located on the first edge of the mesh network 120 and a second router 124 located on the second edge of the mesh network 120 and may include a fusion router 126. The system 100 may include more or fewer devices than that shown in FIG. 1. Each of these components may be virtual, and/or one or more may be implemented by a stand-alone server or computational device configured to execute one or more stored instructions, such as those described with regards to FIG. 4.

The system 100 may include one or more computational devices, including the local device 110 and one or more external devices 112. The local device 110 and external devices 112 may be any computational device that connects to the mesh network 120. The local device 110 and external devices 112 may be workstations, servers, kiosks, computers, sensors, storage devices, tablets, smartphones, and/or other computational devices. The local device 110 and external devices 112 may take any form configured to execute one or more stored instructions. In one or more embodiments, the local device 110 and external devices 112 may be in the form of the computational device 400 described in FIG. 4.

In one or more embodiments, the local device 110 may connect to other external devices 112. These external devices 112 may be located within the same mesh network 120, or they may be connected through larger networks such as, but not limited to, the Internet. The external devices 112 may also be workstations, servers, kiosks, computers, sensors, storage devices, tablets, smartphones, and/or other computational devices, similar to local devices 110. The external device 112 may be in the form of a computational device 400 as described with regards to FIG. 4. External devices 112 may provide services such as email or database services to the local device 110. External devices 112 may also provide applications to the local device 110.

In one or more embodiments, the local device 110 may require DHCP services. DHCP is a network management protocol used on Internet protocol (IP) networks for automatically assigning IP addresses and other communication parameters to devices connected to the network using a client-server architecture. The DHCP services allow the local device 110 to be configured to communicate through the mesh network 120 to other external devices 112. As will be described in more detail below, the local device 110 receives its IP address and other communication parameters from a DHCP server 130 using a plurality of messages, and the local device 110 must periodically renew those services.

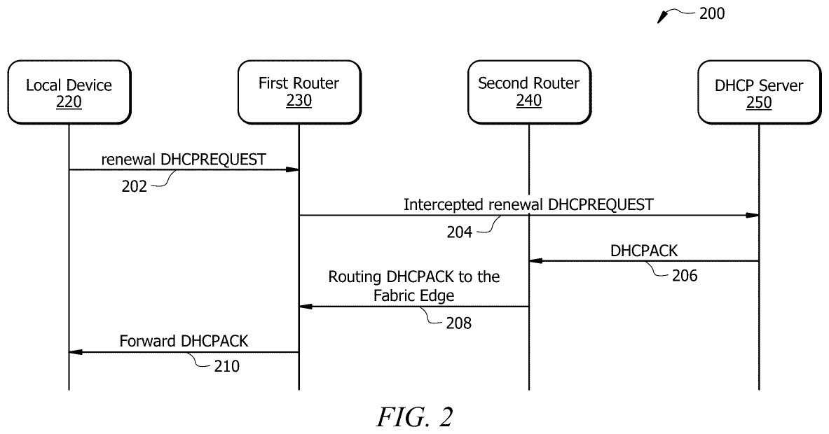

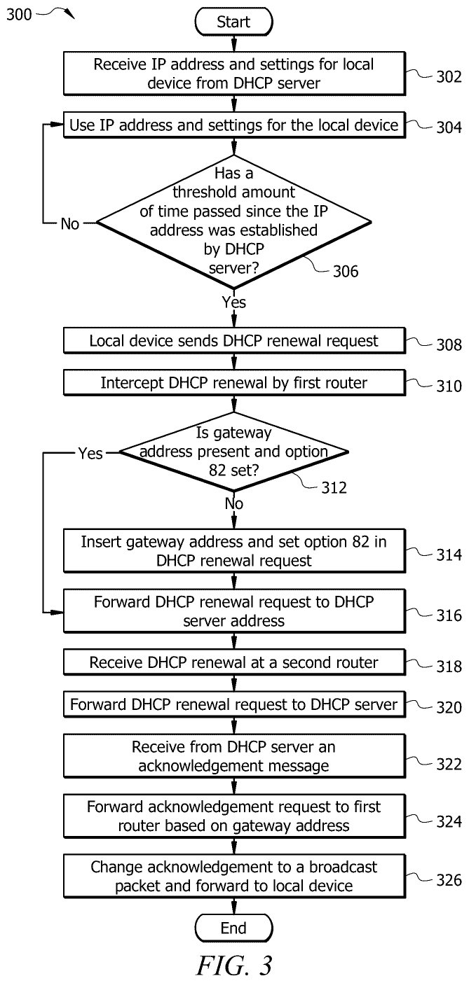

The local device 110 communicates to the DHCP server 130 through a mesh network 120. In one or more embodiments, the mesh network 120 is an SDA network with a client-relay-server topology. However, the mesh network 120 may take any form and is not limited to a mesh topology or a client-relay-server topology. The mesh network 120 includes a plurality of network components, including a first router 122, a second router 124, and a fusion router 126. The first router 122 and second router 124 may be relay routers positioned on a first and second edge, respectively. In one or more embodiments, the first router 122 serves as a gateway for the local device 110. In one or more embodiments, the second router 124 is a border router located on a second edge of the mesh network 120 and forwards packets to a fusion router 126. In one or more other embodiments, the fusion router 126 and the second router 124 are the same physical or software-defined devices. The first router 122, the second router 124, and fusion router 126, as well as other components of the mesh network 120, maybe virtual, and/or one or more, may be implemented by a stand-alone computational device or switch configured to execute one or more stored instructions, such as those described with regards to FIGS. 2 and 3. The components of the mesh network 120 may take the form of the computational device described in FIG. 4 or any other form.

The mesh network 120 comprises a network fabric in one or more embodiments. The network fabric comprises a mesh of connections between network devices such as access points, switches, and routers such as the first router 122 and second router 124. These network devices transport data to its destination. The network fabric may correspond to the physical wirings that make up these connections. Still, in other embodiments, it may comprise a virtualized overlay of connections on top of the physical topology. One such virtualized overlay of connections is an SDA network.

The physical, or underlay, part of the SDA fabric comprises switches, routers, and Wi-Fi devices. The underlay provides a simple, scalable, and robust foundation for communication among network devices. The virtualized, or overlay, part of a network fabric is used for transporting user data. The virtualized part of the fabric is created by adding specific headers to data packets. Network devices interpret these headers and either block or let packets through. This conditional routing makes it appear that a different network is in place that connects only a subset of devices, depending on the headers. Virtualization provides value in a network fabric. A network's underlay may be virtualized and partitioned into several overlay networks that may be optimized individually to meet diverse needs with distinct policies. The fabric also has extensive policy-based control and automation mechanisms that allow it to respond rapidly to any modifications based on business needs.

Returning to FIG. 1, the mesh network 120 may include a first router 122 and a second router 124 located on the edges of the mesh network 120 for communication to local devices 110 and external devices 112. The first router 122 and second router 124 may be relay agents. One or more of the routers, e.g., the second router 124, located on the edge of the mesh network 120, may also be connected to an optional fusion router 126 for communicating with such things as a DHCP server 130. Alternatively, the second router 124 may communicate directly to the DHCP server 130.

A fusion router 126 is a device that enables virtual routing, forwarding, and/or leaking of packets across SDA fabric domains and allows host connectivity to share resources. Such resources may include DHCP, domain name services (DNS), wireless LAN, and other services. A fusion router 126 is provided between the second router 124 and the DHCP server 130 in one or more embodiments of the disclosure. The fusion router 126 facilitates the DHCP server 130 communicating through the mesh network 120 to the appropriate external devices 112 and/or the local device 110. For example, the fusion router 126 may receive a DHCP acknowledgment directed to the local device 110 from the DHCP server 130 and allow it to be leaked or forwarded into the SDA fabric, where the DHCP acknowledgment is sent to the gateway address of the first router 122.

The mesh network 120 communicates to the local device 110, fusion router 126, and/or DHCP server 130 through a first router 122 and a second router 124. The first router 122 and second router 124 are network devices that forward data packets between computer networks such as the mesh network 120 and/or the Internet. The first router 122 and/or second router 124 may also serve as gateways for communicating between the local device 110, the mesh network 120, and the DHCP server 130 when performing DHCP and may serve as a DHCP relay agent.

A DHCP relay agent is any host that forwards DHCP packets between clients and servers. Relay agents are used to forward requests and replies between clients and servers when they are not on the same physical subnet. Relay agent forwarding is distinct from the normal forwarding of an IP router, where IP datagrams are switched between networks somewhat transparently. By contrast, relay agents receive DHCP messages and then generate a new DHCP message to send on another interface.

The mesh network 120 may include additional devices and/or types such as any combination of personal area networks (PANs), local area networks (LANs), campus area networks (CANs), metropolitan area networks (MANs), extranets, intranets, the Internet, short-range wireless communication networks (e.g., ZigBee, Bluetooth, etc.), wide area networks (WANs)-both centralized and/or distributed-and/or any combination permutation, and/or aggregation thereof. The mesh network 120 may include devices, virtual resources, or other nodes that relay packets from one network segment to another by nodes in the computer network. The mesh network 120 may include multiple devices that utilize the network layer (and/or session layer, transport layer, etc.) in the OSI model for packet forwarding and/or other layers. The mesh network 120 may include various hardware devices, such as routers, including but not limited to the first router 122, the second router 124, and the fusion router 126. Switches, gateways, network interfaces (NICs), application-specific integrated circuits (ASICs), field-programmable gate arrays (FPGAs), servers, and/or any other type of devices may also be included in the mesh network 120. Further, the mesh network 120 may include virtual resources, such as virtual machines (VMs), containers, and/or other virtual resources. Additionally, or alternately, the techniques described herein are applicable to container technology, such as Docker®, Kubernetes®, and so forth.

In order to provide the DHCP services to the local device 110 and/or external device 112, system 100 includes a DHCP server 130. The DHCP server 130 may be a stand-alone computational device or may be part of one or more routers, e.g., fusion router 126 or second router 124, associated with the mesh network 120. The DHCP server 130 is a network server that automatically provides and assigns IP addresses, default gateways, and other network parameters to client devices such as the local device 110 and/or external devices 112. The DHCP server 130 utilizes a dynamic host configuration protocol as defined in RFC 2131. A plurality of DHCP servers 130 may be connected to the mesh network 120 in one or more embodiments.

DHCP is based on the bootstrap protocol (BOOTP), which provides the framework for passing configuration information to hosts on a TCP/IP network. DHCP adds the capability to automatically allocate reusable network addresses and configuration options to devices such as the local device 110 and external devices 112. DHCP is built on a client/server model, where a designated DHCP server 130 allocates network addresses and delivers configuration parameters to dynamically configured devices, e.g., 110 and 112. Parameters and other control information are stored in tagged data items in the DHCP packets' options fields.

In one or more embodiments, the DHCP server 130 is deployed to provide IP address and other DHCP services to devices connected to a mesh network 120. The DHCP server 130 may be connected to a fusion router 126 for communicating with the mesh network 120 or may be directly connected to the mesh network 120. When deployed with a complex network such as mesh network 120, the DHCP server may have a different subnet than that of the local device 110 and/or external devices 112 that it provides DHCP services to.

Option 82 is organized as a single DHCP portion of the DHCP packet. This option identifies both the DHCP relay agent, e.g., the first router 122, and the virtual network identifier (VNI) that the local device 110 that sent the DHCP discovery and/or renewal messages or packets is associated with. When the DHCP server 130 receives any DHCP messages with option 82, it adds the information from the DHCP option 82 of the received DHCP message to any replies. The relay agent, e.g., the second router 124, receiving the reply such as a DHCPACK from the DHCP server 130, uses the information from this option or field to determine where to send the message/packet back to.

However, this option is insufficient to ensure that the DHCPACK or other response from the DHCP server 130 is routed back to the appropriate first router 122 and/or local device 110 when the network is a mesh network 120, such as an SDA network. Unless specifically configured, a fusion router 126 situated either physically or virtually between the DHCP server 130 and the second router 124 will often drop the DHCPACK response. To overcome this, one or more embodiments add an additional field to the initial DHCP message, such as the DHCP renewal message. The additional field is a GIADDR value, which comprises an IP address for the gateway or first router 122. This, along with information added to the option 82 field of the message by the gateway or first router 122, allows any reply from the DHCP server 130 to pass through the fusion router 126 to the second router 124 successfully, as will be described in more detail with regards to FIGS. 2 and 3.

FIG. 1 illustrates a particular arrangement of system 100, which performs DHCP renewal with a mesh network 120. Furthermore, FIG. 1 describes and illustrates particular components, devices, or systems carrying out particular actions; this disclosure contemplates any suitable combination of any suitable components, devices, or systems carrying out any suitable actions.

FIG. 2 shows example signaling 200 between a local device 220, a first router 230, a second router 240, and a DHCP server 250 when the local device 220 requests the renewal of an IP address from the DHCP server 250. Each of these components may take the form of the components described above with regards to FIG. 1, or any of the components or all of the components described in FIG. 2 may be different than those shown in FIG. 1. Local device 220 may be the same or a different device then that shown in FIG. 1 as local device 110. Similarly, the first router 230 may correspond to the first router 122. The second router 240 may correspond to the second router 124 and/or the fusion router 126. The DHCP server 250 may correspond to the DHCP server 130. Signaling 200 may be performed between more or fewer components than shown in FIG. 2.

Initially, the local device 220 sends a DHCP renewal request packet 202 (renewal DHCPREQUEST) as a unicast packet to the DHCP server 250, which had initially established the IP address for the local device 220. The first router 230 on the SDA edge intercepts the renewal DHCPREQUEST packet 202. The first router 230 is the router on the SDA edge that is physically and/or virtually nearest to the local device.

The first router 230, which acts as a relay agent for forwarding packets such as the renewal DHCPREQUEST packet 202, modifies the renewal DHCPREQUEST packet 202. Once the first router 230 intercepts the renewal DHCPREQUEST packet 202, the first router 230 or a network device connected to the first router 230 inserts option 82 and a GIADDR value corresponding to the first router 230. Alternatively, in one or more embodiments, a separate network or computing device changes the renewal DHCPREQUEST packet 202 before the first router 230 forwards the renewal DHCPREQUEST packet 202 as an intercepted renewal DHCPREQUEST packet 204 to the DHCP server 250.

Once the renewal DHCPREQUEST packet 202 has option 82 inserted along with a GIADDR value, the intercepted renewal DHCPREQUEST packet 204 is forwarded through the mesh network (e.g., mesh network 120 of FIG. 1) and to an edge or border router, second router 240. In certain embodiments, the second edge router 240 directly forwards the intercepted renewal DHCPREQUEST packet 204 to the DHCP server 250. In some embodiments, the second edge router 240 forwards the intercepted renewal DHCPREQUEST packet 204 to the DHCP server 250 through a fusion router 126 as described in FIG. 1. The fusion router 126 allows the DHCP server 250 to communicate with the mesh network 120 when the DHCP server 250 is not part of or directly connected to the mesh network 120.

The DHCP server 250, as described above in FIG. 1, formulates configuration parameters and initially establishes the IP address and other configuration parameters. The DHCP server 250, during a discovery process (not shown), offers configuration parameters (such as an IP address, a domain name, and a lease for the IP address) to the local device 220.

Once the DHCP server 250 receives the intercepted renewal DHCPREQUEST packet 204, the DHCP server 250 sends a DHCPACK packet 206 back to the local device 220. Because the intercepted renewal DHCPREQUEST packet 204 includes the option 82 and GIADDR value, the DHCPACK packet 206 is sent as a unicast packet through a fusion router, e.g., 126, FIG. 1, to the second router 240 or directly to the second router 240, which is located on a second edge closest to the DHCP server 250.

The second router 240 routes the DHCPACK packet 208 through the mesh network, e.g., 120, FIG. 1, to the first router 230. The first router 230 then receives the routed DHCPACK packet 208 and changes the routed DHCPACK packet 208 to a broadcast packet, which is then communicated or sent as a broadcast DHCPACK message 210 to the local device 220. Alternatively, the DHCPACK may be communicated to the local device from the first router 230 as a unicast packet. The local device 220 may use the information received in the broadcast DHCPACK message 210 to renew its IP address.

The signaling 200 shown in FIG. 2 and described above is exemplary, and the disclosure is not limited to the specific components and signals described. The signaling 200 may involve more or fewer routers than shown and may or may not be performed using a mesh network (e.g., mesh network 120 of FIG. 1) and/or SDA fabric network.

FIG. 3 illustrates an example method 300 for performing DHCP renewal in an SDA mesh network. In one or more embodiments, method 300 is performed by the first router 122, as shown and described above with regards to FIG. 1. In certain embodiments, method 300 may be performed by any system 100 comprising a local device 110, a mesh network 120, one or more routers, e.g., first router 122 and second router 124, fusion router 126, and DHCP server 130. The method 300 is not limited to being performed by the system shown in FIG. 1 or with the messages and/or signaling as described above with regards to FIG. 2.

Method 300 begins at step 302. In step 302, the local device (e.g., local device 110 of FIG. 1 or local device 220 of FIG. 2) receives an IP address and settings from a DHCP server (e.g., DHCP server 130 of FIG. 1 or DHCP server 250 of FIG. 2). This may be done using the procedures outlined in RFC 2131, which is incorporated herein by reference. In one or more alternative embodiments, the IP address and settings may be established by a different method and/or without using the DHCP server.

Once the IP address and setting are received by the local device from the DHCP server in step 302, the method proceeds to step 304. In step 304, the local device uses the assigned IP address and other settings to communicate through a first router (e.g., first router 122 of FIG. 1 or first router 230 of FIG. 2) and a mesh network (e.g., the mesh network 120 of FIG. 1) in order to interact with one or more external devices (e.g., external devices 112 of FIG. 1). The local device continues to utilize the assigned IP address as indicated in step 306 until a predetermined amount of time passes or the local device ceases to require an IP address, e.g., in a non-limiting example, the local device is powered off.

In step 306, method 300 determines if a threshold amount of time has passed since the IP address was established by the DHCP server. The threshold amount of time is based on the lease duration provided by the DHCP server when the IP address and setting are received in step 302. This threshold time is typically fifty percent of the lease duration. Typically, the lease time is established by the DHCP server to be one day or twenty-four hours. However, other time periods, such as one hour, one week, or any combination of minutes, hours, days, and weeks, may be used without departing from the disclosure. Using the typical twenty-four hours, the threshold time would be twelve hours. However, other percentages of the lease duration may be used without departing from the disclosure.

If method 300 determines in step 306 that the threshold amount of time has not passed, then the method returns to step 304; however, if the threshold amount of time, for example, twelve hours, has passed, method 300 proceeds to step 308, where the local device begins the DHCP renewal process by sending a DHCP renewal request. This DHCP renewal request is typically sent as a unicast packet addressed to the DHCP server that provided the initial IP address and settings.

In step 310, this renewal packet is intercepted by the first router. The first router may be an edge node of the mesh network, a relay router, or may take any other form. The first router analyzes the renewal packet and determines if a gateway address or GIADDR is present and if option 82 is set. The method 300 proceeds to 312, where if the GIADDR is present and option 82 is set, the method proceeds to step 316. However, if the GIADDR is not present or option 82 is not set, the method proceeds to step 314.

In step 314, either the first router or other network equipment associated with the first router inserts a gateway address or GIADDR value in the renewal packet and sets option 82. The GIADDR value is set as the gateway address of the first router. Option 82 indicates that the response to the renewal packet should be sent to the first router to relay to the local device.

Once both the gateway address (or GIADDR value) and option 82 are set in the renewal request packet in step 314 or when they are present in the initial DHCP renewal intercepted by the first router, the first router forwards the DHCP renewal request packet to the DHCP server address in step 316. The DHCP renewal request packet is sent through the mesh network to a second router (e.g., second router 124 of FIG. 1 or second router 240 of FIG. 2), which may be an edge node located on the edge closest to the DHCP server. The second router may take any form and may be a relay router, switch, or gateway.

The second router receives the DHCP renewal packet in step 318 and forwards the DHCP renewal request to the DHCP server in step 320. In one or more embodiments, when the DHCP server is not part of the mesh network, the DHCP renewal request is forwarded through an optional fusion router (e.g., fusion router 126 of FIG. 1) to the DHCP server.

The second router receives an acknowledgment packet from the DHCP server in step 322. This acknowledgment packet indicates that the IP address is being renewed, and a new lease time has been established. Because the DHCP renewal request packet included option 82 and/or the GIADDR entry, the acknowledgement packet takes the form of a unicast packet and is forward to the second router.

The second router then forwards the acknowledgment packet as a unicast packet to the first router based on the gateway address, e.g., GIADDR value in step 324. Once the first router receives the acknowledgment packet in step 324, it optionally changes the packet to a broadcast packet and forwards it to the local device in step 326, which continues to use the assigned IP address. Alternatively, the acknowledgment packet may be forwarded to the local device in step 326 as unicast packet. The method may then end after step 326. This disclosure describes and illustrates the particular steps of method 300 in FIG. 3 as occurring in a particular order, this disclosure contemplates any suitable steps of method 300 of FIG. 3 occurring in any suitable order.

Although this disclosure describes and illustrates an example method for renewing DHCP in a mesh or SDA network using the particular steps of the method of FIG. 3, this disclosure contemplates any suitable method for renewing DHCP in an SDA mesh network, which may include all, some, or none of the steps of the method of FIG. 3, where appropriate. Although FIG. 3 describes and illustrates particular components, devices, or systems carrying out particular actions. This disclosure contemplates any suitable combination of any suitable components, devices, or systems carrying out any suitable actions.

FIG. 4 shows an example computer architecture for a computational device 400 capable of executing program components for implementing the functionality described above. The computer architecture shown in FIG. 4 illustrates any type of computational device 400, such as a switch, router, wireless controller, conventional server computer, workstation, desktop computer, laptop, tablet, network appliance, e-reader, smartphone, or other computing device, and may be utilized to execute any of the software components presented herein. The computational device 400 may, in some examples, correspond to any of the devices, such as the local device 110, the external device 112, the first router 122, the second router 124, the fusion router 126, and the DHCP server 130 as shown in FIG. 1, and/or any other device described therein as well as with regards to FIG. 2. The computational device 400 may comprise personal devices (e.g., smartphones, tablets, wearable devices, and laptop devices), networked devices, such as servers, switches, routers, hubs, bridges, gateways, modems, repeaters, access points, and/or any other type of computing device that may be running any type of software and/or virtualization technology.

In particular embodiments, one or more computational devices 400 perform one or more steps of one or more methods described or illustrated herein, such as the methods described with respect to FIG. 3. In particular embodiments, one or more computational devices 400 provide the functionality described or illustrated herein, such as the functionality described with respect to FIGS. 1-3. In particular embodiments, software running on one or computational device 400 performs one or more steps of one or more methods described or illustrated herein or provides functionality described or illustrated herein. Particular embodiments include one or more portions of one or more computational devices 400.

Particular embodiments may include any suitable number of computational devices 400. Computational device 400 may take any suitable physical form. As example and not by way of limitation, computational device 400 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computational device 400 may include one or more computational devices 400; be unitary or distributed; span multiple locations; span multiple machines; span multiple data centers; or reside in a cloud, which may include one or more cloud components in one or more networks.

Where appropriate, one or more computational devices 400 may perform without substantial spatial or temporal limitation one or more steps of one or more methods described or illustrated herein. As an example, and not by way of limitation, one or more computational devices 400 may perform in real-time or in batch mode one or more steps of one or more methods described or illustrated herein. One or more computational devices 400 may perform at different times or at other locations one or more steps of one or more methods described or illustrated herein, where appropriate.

In particular embodiments, computational device 400 includes a processor 402, memory 404, storage 406, an input/output (I/O) interface 408, a communication interface 410, and a bus 412. Although this disclosure describes and illustrates a particular computational device or node having a particular number of particular components in a particular arrangement, particular embodiments may include any suitable computer system having any suitable number of any suitable components in any suitable arrangement.

In particular embodiments, processor 402 includes hardware for executing instructions, such as those making up a computer program. As an example, and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. Processor 402 may include any number of suitable internal caches, where appropriate.

As an example, and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual address translation for processor 402.

In particular embodiments, processor 402 may include one or more internal registers for data, instructions, or addresses. Processor 402 may include any suitable number of any suitable internal registers, where appropriate. Where appropriate, processor 402 may include one or more arithmetic logic units (ALUs), be a multi-core processor, or include one or more processors 402. Although this disclosure describes and illustrates a particular processor, particular embodiments may include any suitable processor.

In particular embodiments, memory 404 includes main memory for storing instructions for processor 402 to execute or data for processor 402 to operate on. As an example, and not by way of limitation, computational device 400 may load instructions from storage 406 or another source (such as, for example, another computational device 400) to memory 404. Processor 402 may then load the instructions from memory 404 to an internal register or internal cache.

To execute the instructions, processor 402 may retrieve the instructions from the internal register or internal cache and decode them. During or after the execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere).

One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate access to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where applicable, this RAM may be single-ported or multi-ported RAM. Particular embodiments may include any suitable RAM. Memory 404 may include one or more memories 404, where appropriate. Although this disclosure describes and illustrates a particular memory, particular embodiments may include any suitable memory.

In particular embodiments, storage 406 includes mass storage for data or instructions. As an example, and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to the computational device 400, where appropriate. In particular embodiments, storage 406 is a non-volatile, solid-state memory. In particular embodiments, storage 406 includes read-only memory (ROM). Where applicable, this ROM may be mask-programmed ROM, programmable ROM (PROM), erasable PROM (EPROM), electrically erasable PROM (EEPROM), electrically alterable ROM (EAROM), flash memory, or a combination of two or more of these. Storage 406 may take any suitable physical form.

Storage 406 may include one or more storage control units facilitating communication between processor 402 and storage 406, where appropriate. Where appropriate, storage 406 may include one or more storages 406. Although this disclosure describes and illustrates particular storage, particular embodiments may include any suitable storage.

In particular embodiments, I/O interface 408 includes hardware, software, or both, providing one or more interfaces for communication between a computational device 400 and one or more I/O devices. Computational device 400 may include one or more of these I/O devices, where appropriate. One or more of these I/O devices may enable communication between a person and computational device 400. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. Particular embodiments may include any suitable I/O devices, and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, particular embodiments may include any suitable I/O interface. In particular embodiments, I/O interface 408 may include an interface to a remote network management system.

In particular embodiments, communication interface 410 includes hardware, software, or both providing one or more interfaces for communication (such as, for example, packet-based communication) between computational device 400 and one or more other computational devices 400 or one or more networks. As an example, and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network.

Particular embodiments may include any suitable network and any suitable communication interface 410 for it. As an example, and not by way of limitation, computational device 400 may communicate with an ad hoc network, a personal area network (PAN), a LAN, WAN, MAN, or one or more portions of the Internet or a combination of two or more of these. One or more portions of one or more of these networks may be wired or wireless. As an example, computational device 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computational device 400 may include any suitable communication interface 410 for any of these networks, where appropriate. Communication interface 410 may include one or more communication interfaces 410, where applicable. Although this disclosure describes and illustrates a particular communication interface, particular embodiments may include any suitable communication interface.

In particular embodiments, bus 412 includes hardware, software, or both coupling components of the computational device 400 to each other. As an example and not by way of limitation, bus 412 may include an Accelerated Graphics Port (AGP) or other graphics bus, an Enhanced Industry Standard Architecture (EISA) bus, a front-side bus (FSB), an HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, particular embodiments may include any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable, non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

While the disclosure is described with respect to the specific examples, it is to be understood that the scope of the disclosure is not limited to these specific examples. Since other modifications and changes varied to fit particular operating requirements and environments will be apparent to those skilled in the art, the disclosure is not considered limited to the example chosen for purposes of disclosure and covers changes and modifications that do not constitute departures from the true spirit and scope of this disclosure.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed:

1. A method for performing dynamic host configuration protocol (DHCP) renewal comprising:
intercepting, by a first router, a DHCP renewal request communicated by a local device to a remote DHCP server, wherein the first router is one of a plurality of routers positioned between the local device and the remote DHCP server and wherein the plurality of routers form a mesh network;
determining, by the first router, if a gateway address and DHCP options are present in the DHCP renewal request, wherein the gateway address is an address of the first router;
adding, by the first router, the gateway address and a DHCP option to the DHCP renewal request when it is determined that the gateway address and DHCP options are not present in the DHCP renewal request;
forwarding, by the first router, the DHCP renewal request from the first router to the remote DHCP server;
receiving, by the first router, an acknowledgment communicated by the remote DHCP server, wherein the acknowledgment is communicated to the gateway address; and
forwarding, by the first router, the acknowledgment to the local device.

2. The method of claim 1, further comprising:
receiving the acknowledgment from a second router, wherein the second router is positioned between the first router and the remote DHCP server.

3. The method of claim 1, further comprising:
receiving the acknowledgment as a unicast packet from a fusion router, wherein the fusion router is positioned between the first router and the remote DHCP server.

4. The method of claim 1, wherein the remote DHCP server and the local device have a different subnet.

5. The method of claim 1, wherein adding the DHCP option to the DHCP renewal request comprises setting option 82 in the DHCP renewal request.

6. The method of claim 1, wherein the first router receives the acknowledgment as a unicast message and forwards the acknowledgment to the local device as a broadcast.

7. The method of claim 1, wherein:
the first router is an edge node of the mesh network; and
the mesh network is a software-defined access (SDA) network.

8. A first router, comprising:
one or more processors; and
one or more computer-readable non-transitory storage media coupled to the one or more processors that stores instructions operable when executed by the one or more processors to cause the first router to perform operations comprising:
intercepting a DHCP renewal request communicated by a local device to a remote DHCP server;
determining if a gateway address and DHCP options are present in the DHCP renewal request, wherein the gateway address is an address of the first router;
adding the gateway address and a DHCP option to the DHCP renewal request when it is determined that the gateway address and DHCP options are not present in the DHCP renewal request;
forwarding the DHCP renewal request from the first router to the remote DHCP server;
receiving an acknowledgment communicated by the remote DHCP server, wherein the acknowledgment is communicated to the gateway address; and
forwarding the acknowledgment to the local device.

9. The first router of claim 8, wherein the operations further comprise:
receiving the acknowledgment from a second router, wherein the second router is positioned between the first router and the remote DHCP server.

10. The first router of claim 8, wherein the operations further comprise:
receiving the acknowledgment as a unicast packet from a fusion router, wherein the fusion router is positioned between the first router and the remote DHCP server.

11. The first router of claim 8, wherein the remote DHCP server and the local device have a different subnet.

12. The first router of claim 8, wherein adding the DHCP option to the DHCP renewal request comprises setting option 82 in the DHCP renewal request.

13. The first router of claim 8, wherein the first router receives the acknowledgment as a unicast message and forwards the acknowledgment to the local device as a broadcast.

14. The first router of claim 8, wherein:
the first router is an edge node of a mesh network; and
the mesh network is a software-defined access (SDA) network.

15. One or more computer-readable non-transitory storage media embodying instructions that, when executed by a processor, cause the processor to perform operations comprising:
intercepting, by a first router, a DHCP renewal request communicated by a local device to a remote DHCP server, wherein the first router is one of a plurality of routers positioned between the local device and the remote DHCP server and wherein the plurality of routers form a mesh network;
determining, by the first router, if a gateway address and DHCP options are present in the DHCP renewal request, wherein the gateway address is an address of the first router;
adding, by the first router, the gateway address and a DHCP option to the DHCP renewal request when it is determined that the gateway address and DHCP options are not present in the DHCP renewal request;
forwarding, by the first router, the DHCP renewal request from the first router to the remote DHCP server;
receiving, by the first router, an acknowledgment communicated by the remote DHCP server, wherein the acknowledgment is communicated to the gateway address; and
forwarding, by the first router, the acknowledgment to the local device.

16. The one or more computer-readable non-transitory storage media of claim 15, wherein the operations further comprise:
receiving the acknowledgment from a second router, wherein the second router is positioned between the first router and the remote DHCP server.

17. The one or more computer-readable non-transitory storage media of claim 15, wherein the operations further comprise:
receiving the acknowledgment as a unicast packet from a fusion router, wherein the fusion router is positioned between the first router and the remote DHCP server.

18. The one or more computer-readable non-transitory storage media of claim 15, wherein adding the DHCP option to the DHCP renewal request comprises setting option 82 in the DHCP renewal request.

19. The one or more computer-readable non-transitory storage media of claim 15, wherein the first router receives the acknowledgment as a unicast message and forwards the acknowledgment to the local device as a broadcast. 20 The one or more computer-readable non-transitory storage media of claim 15, wherein:
the first router is an edge node of the mesh network; and
the mesh network is a software-defined access (SDA) network.
